(19) United States
(12) Patent Application Publication
(10) Pub. No.: US 2017/0259870 A1
(43) Pub. Date: Sep. 14, 2017

(54) Method to reduce bicycle shipping and storage width by the addition of a lockable second axis of rotation for the crank arm

(71) Applicant: Alex Pong, Raymond, WA (US)

(72) Inventor: Alex Pong, Raymond, WA (US)

(73) Assignee: T. Pong Company, Raymond, WA (US)

(21) Appl. No.: 15/069,917

(22) Filed: Mar. 14, 2016

(51) Int. Cl. B62K 15/00; B62M 3/00

(52) U.S. Cl. CPC B62K 15/00; B62M 3/00; B62K 2015/003

(57) ABSTRACT

The addition of a lockable second axis of crank arm rotation roughly parallel to the structural neutral axis of the crank arm enables a reduction in bicycle storage or shipping volume substantially more effectively and easily than current removable or folding pedal designs. This second axis passes through an adapter, one at each end of the bottom bracket. The adapter restricts any motion of the crank arm to normal pedaling or rotating the crank around the second pedal axis to a storage position. A locking key(s) and retainer prevent any inadvertent crank arm movement. This invention is not dependent on pedal design. Any standard pedal may be employed.

### BACKGROUND OF THE INVENTION

Heretofore, in order to reduce bicycle shipping volume and space required for storage, designers have generally reverted to simply removing the pedals. Manufacturers of standard nonfolding bicycles commonly use this method in packaging and shipping new bicycles to retail outlets at which point bicycles are expected to receive final assembly including installation of wheels, handlebars, seat, and pedals.

In the case of a folding bicycle that must by nature be designed especially to accommodate frequent storage and transportation, some designers avoid the inconvenience of requiring tools to complete the removal and reinstallation of the pedals by settling for a threadless quick removal system. However, when a removable pedal is employed on a bicycle designed for frequent folding, a storage place on the bicycle must be provided for the removed pedal and the opportunity for the pedal to be lost, stolen, or misplaced is considerably increased. Other designers more commonly employ one of a few folding pedal designs that reduce the length of the extended pedal by approximately one-half. Activating the release systems that lock these pedals in place often requires a level of hand or finger pressure that makes them frustrating and difficult to operate by anyone with less than strong and agile hands. A bicycle employing one of these special folding pedals designs necessarily removes the rider's option to select one of the many aftermarket standard pedals now available.

### BRIEF SUMMARY OF THE INVENTION

With the addition of a lockable second axis of crank arm rotation, this invention enables a reduction in bicycle storage or shipping volume with greater effectiveness than simple pedal removal and is more convenient to use than the halfway reduction of current folding pedal designs.

The second axis of crank arm rotation is roughly parallel to the structural neutral axis of the crank arm and passes through a crank arm adapter, one each at the ends of the bottom bracket. This adapter connects the crank arm to the bottom bracket and, except for normal pedaling action, restricts all crank arm motion to rotation about the second axis. A locking key or keys in the adapter secure the crank arm against inadvertent rotation but when released, allow the crank arm to rotate through as much as 360° into any of several storage positions.

### BRIEF DESCRIPTION OF THE DRAWINGS

FIG. 1 is an isometric view of a crank set consisting of one chain ring, two crank arm assemblies, and two pedals with one pedal in extended (or riding) configuration and one pedal (and crank arm) at 45° rotation.

FIG. 2 is a top plan view of the crank set, pedals in extended configuration for normal pedaling motion.

FIG. 3 is an end elevation view of the crank set shown in FIG. 2.

FIG. 4 is a top plan view of the crank set, pedals at 45° rotation.

FIG. 5 is an end elevation view of the crank set shown in FIG. 4.

FIG. 6 is a top plan view of the crank set, pedals at 90° rotation.

FIG. 7 is an end elevation view of the crank set shown in FIG. 6.

FIG. 8 is a side elevation view of the crank set shown in FIG. 7.

FIG. 9 is an exploded view of the crank arm assembly.

FIG. 10 is a top plan cross section view of the crank arm assembly shown in FIG. 11.

FIG. 11 is a side elevation of the crank arm adapter portion of the crank arm assembly.

FIG. 12 is a top plan view of the crank arm adapter portion of the crank arm assembly.

FIG. 13 is a side elevation cross section view of the crank arm assembly shown in FIG. 12.

FIG. 14 is a top plan view of the crank arm adapter portion of the crank arm assembly.

FIG. 15 is an end elevation cross section view of the crank arm assembly shown in FIG. 14.

FIG. 16 is a top plan view of the crank arm assembly and extended pedal in riding configuration showing the conical rotation of the structural neutral axis of the crank arm around the second axis of crank arm rotation.

FIG. 17 is the same as FIG. 16 but with the crank arm and pedal rotated 180°.

### DETAILED DESCRIPTION OF THE INVENTION

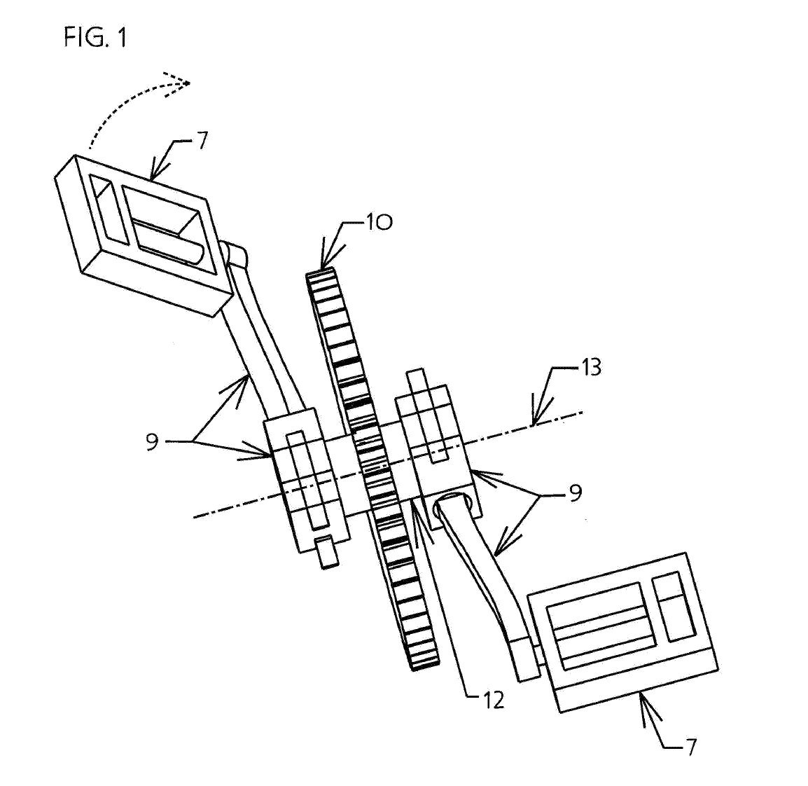

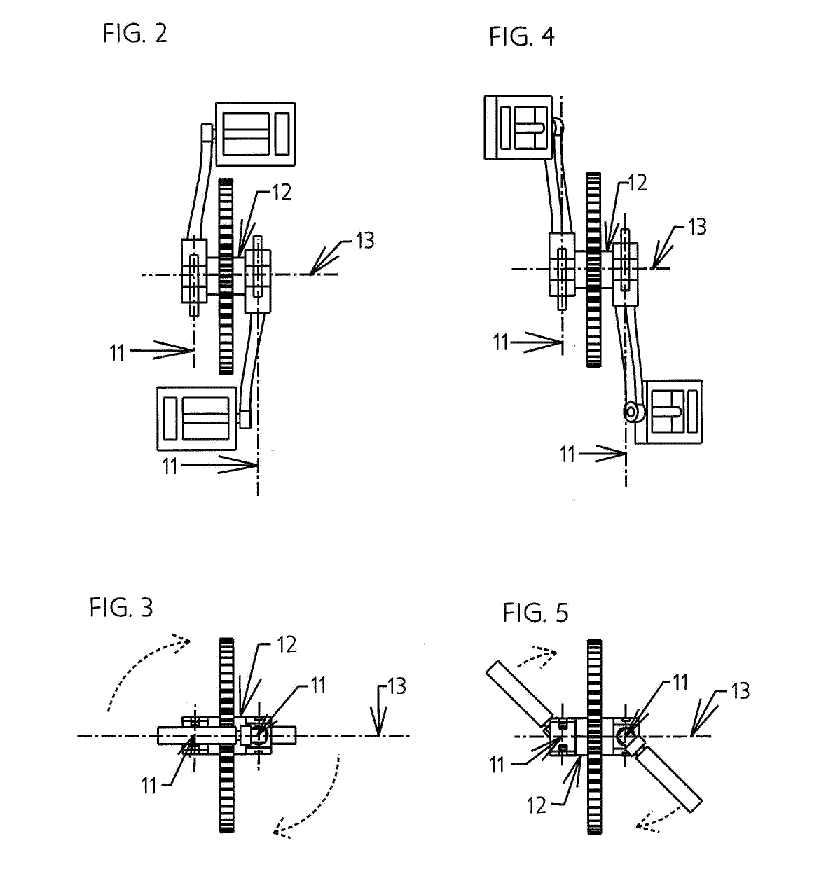

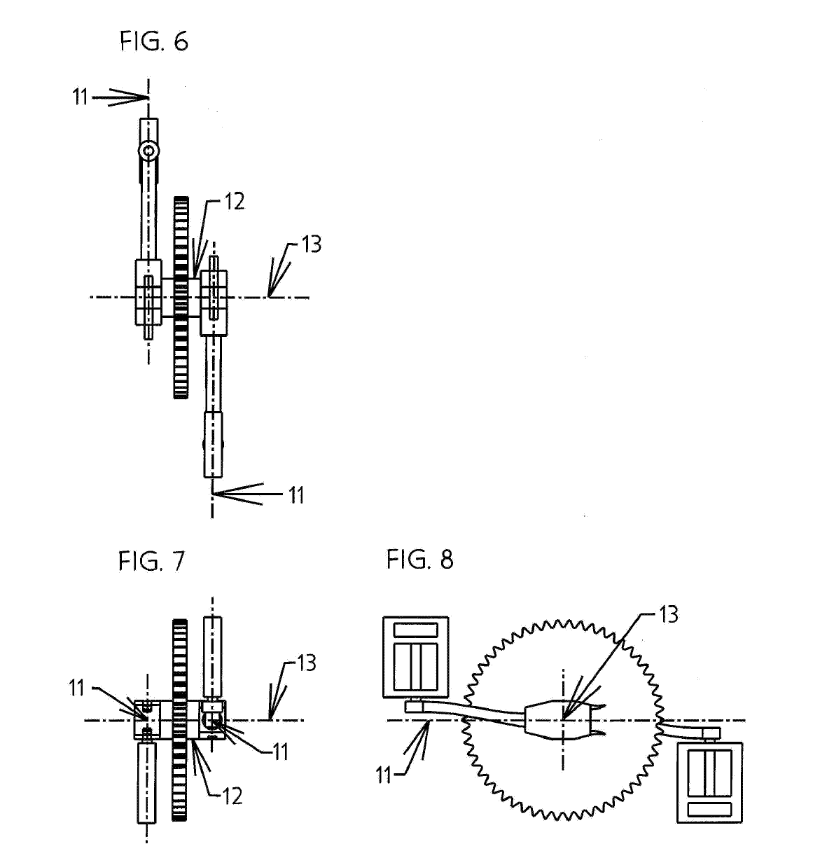

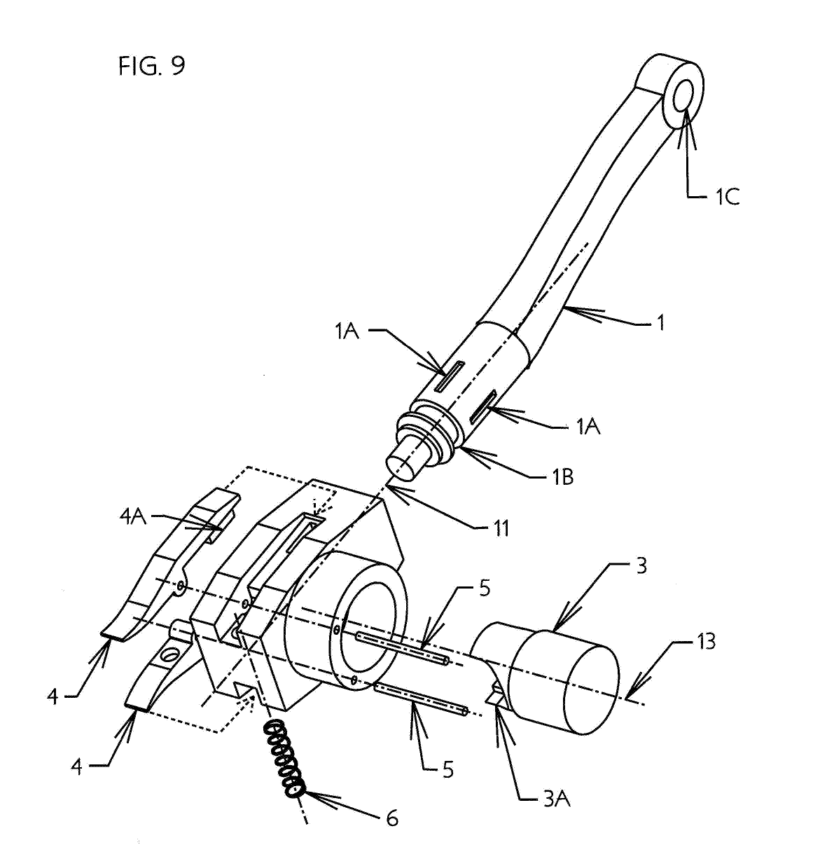

This invention enables a reduction in bicycle storage or shipping volume substantially more effectively (FIGS. 2-8) than simple pedal removal and is at least as convenient to use as the halfway reduction of the pedal extension length of current folding pedal designs. In this invention a crank arm assembly (9) (FIG. 9) replaces the traditional bicycle crank arm. FIG. 1 shows two crank arm assemblies (9) in placement around a bottom bracket (12) and chain ring (10).

The placement of a lockable second axis of crank arm rotation (11) roughly parallel to the structural neutral axis of the crank arm (1) allows the crank arm (1), when released by a locking key or keys, to rotate up to a full 360° around this second axis (FIGS. 2-8). This second axis of crank arm rotation (11) passes through one of two crank arm adapters (2), one each at the ends of the bottom bracket (12). These crank arm adapters (2) are free to rotate around the bottom bracket axis (13) in normal pedaling action but restrict any other movement of the crank arm (1) except for rotation into any of several storage positions.

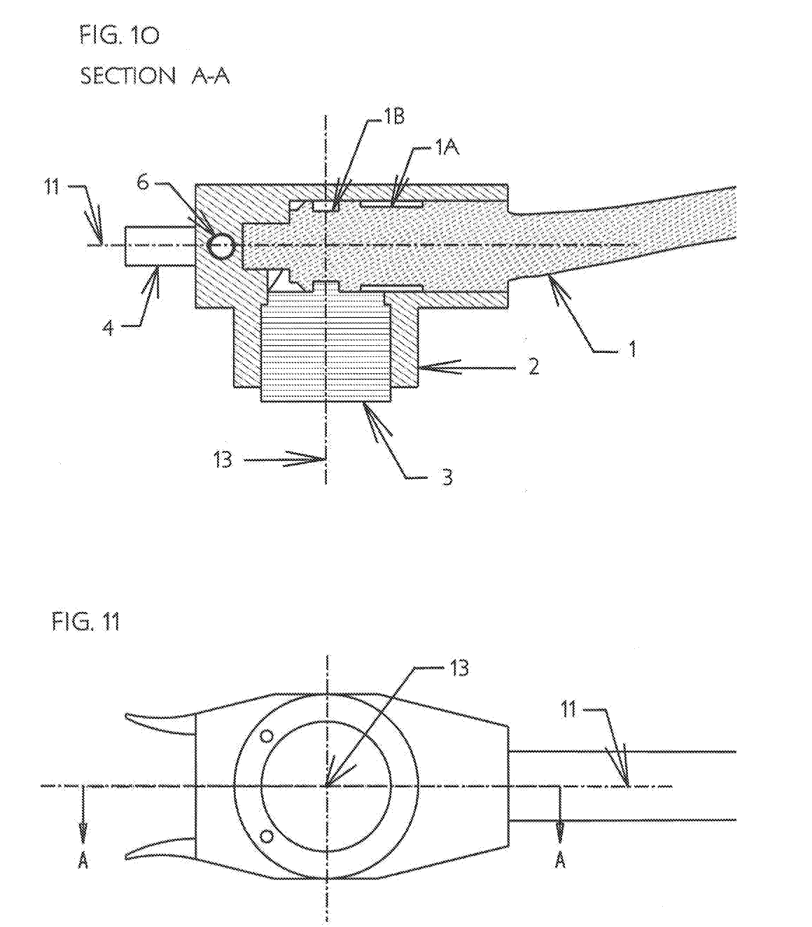

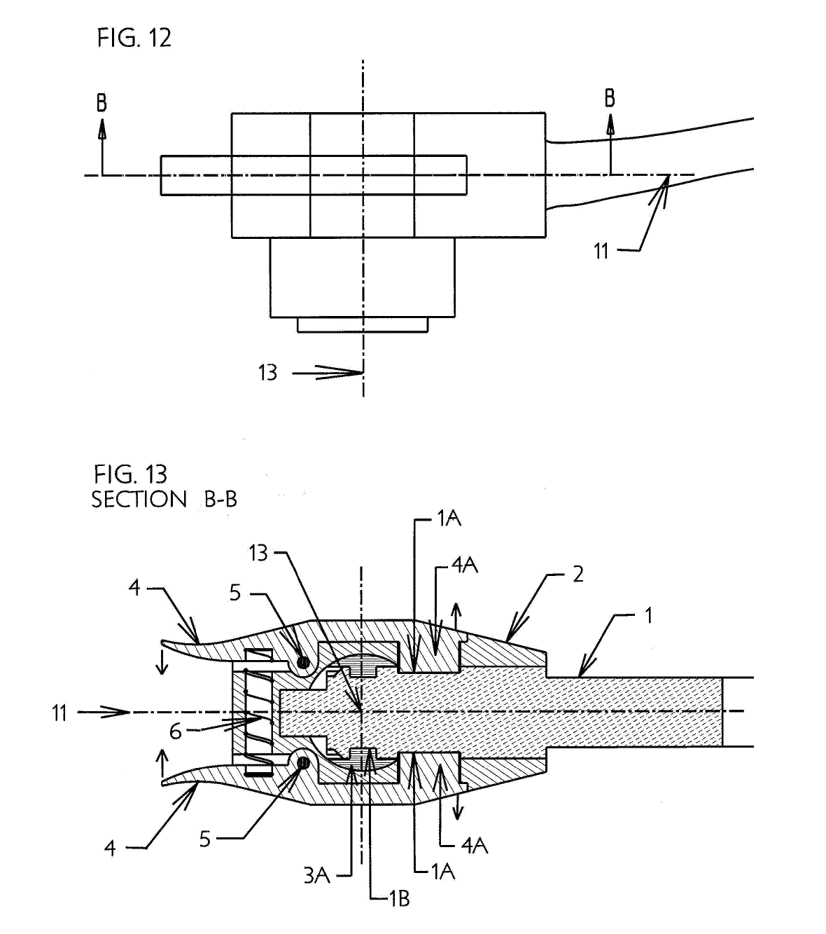

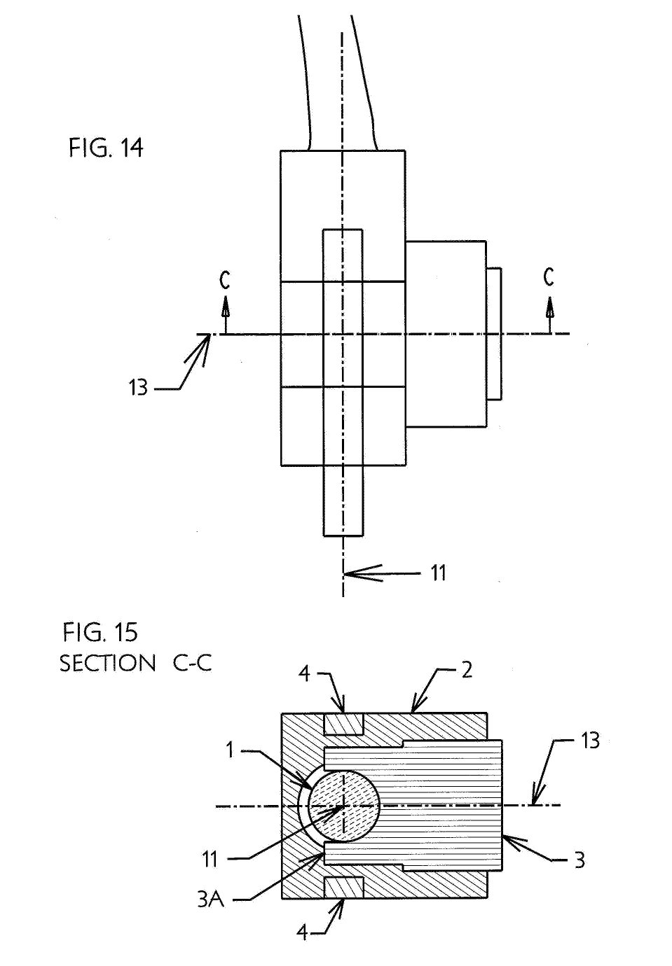

Within the crank arm adapter (2), which is attached at each end of the bottom bracket (12), the round shaft of the crank arm (1) is secured so that any movement along its second axis of rotation is restrained by a crank arm retainer (3). The crank arm retainer (3) inserts into the crank arm adapter (2) on an axis at 90° to the second axis of crank arm rotation. A “U” shaped fork (3A) at one end of the crank arm retainer (3) (FIG. 15) inserts into a circular groove referred to as the crank arm retainer groove (1B) around the crank arm (1) by partially encircling the circumference of the crank arm (1) within the crank arm adapter (2) (FIGS. 10, 13). The crank arm retainer (3) restrains any movement of the crank arm (1) along its second axis of rotation thus preventing it from exiting the crank arm adapter (2) but still allows the entire crank arm (1) to rotate around the second axis of the crank arm rotation (11) as much as 360° thereby changing the pedal (7) from an extended (riding) configuration to a folded configuration (FIGS. 2-8).

The crank arm (1) is locked in its rotational position by means of one or more lock lever keys (4A), a narrow protrusion at one end of the lock lever (4) (FIG. 13). The lock lever (4) is situated in the crank arm adapter (2) where it pivots on a lock lever pin (5). The lock lever key (4A) inserts into the crank arm lock lever groove (1A) (FIGS. 10, 13), a longitudinal groove, in the shaft of the crank arm (1) to lock the crank arm (1) in the correct rotational position. The lock lever (4) is held in place by a lock lever pin (5) and default loaded to a locked position by a lock lever spring (6) within the crank arm adapter (2) that exerts an outward pressure on the outer end of the lock lever (4). This end of the lock lever (4) protrudes sufficiently beyond the end of the crank arm adapter (2) to allow easy finger access (FIG. 13). When pressure is applied against the spring at the protruding end of the lock lever (4), the opposite end of the lock lever (4) moves in the opposing direction and the lock lever key (4A) exits the crank arm lock lever key groove (1A) in the crank arm (1) thereby allowing the crank arm (1) to rotate freely on its second axis of rotation (11). When finger pressure is released, the end of the lock lever (4) is pressured by the spring to return to its default loaded position to once again hold the lock lever key (4A) in the crank arm lock lever key groove (1A) and thus secure the crank arm (1) in position and prevent any further rotation of the crank arm (1).

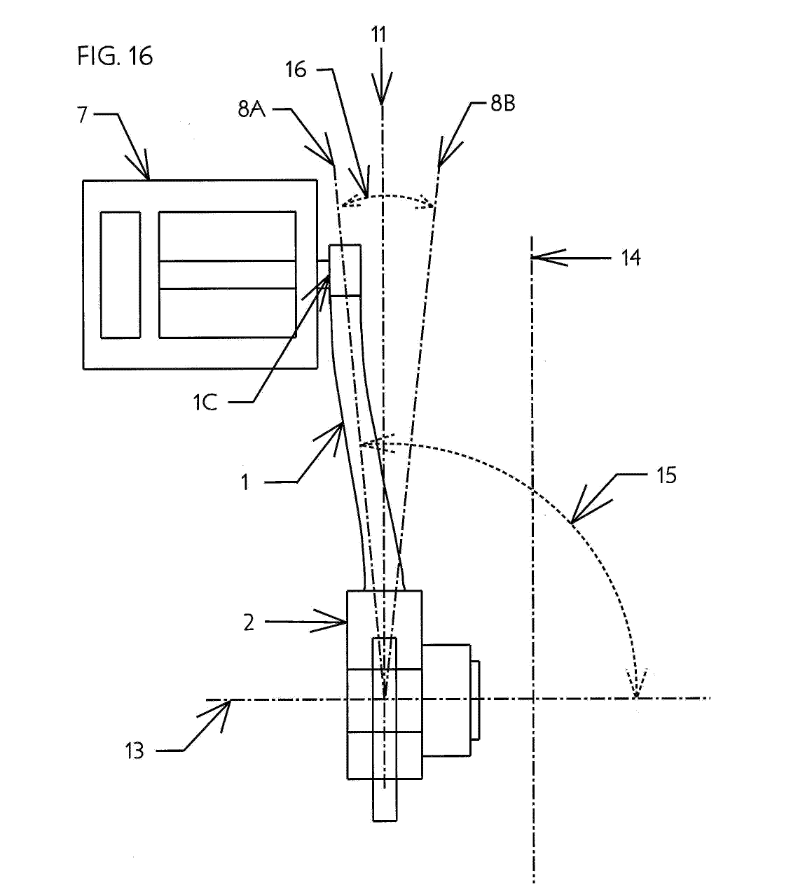

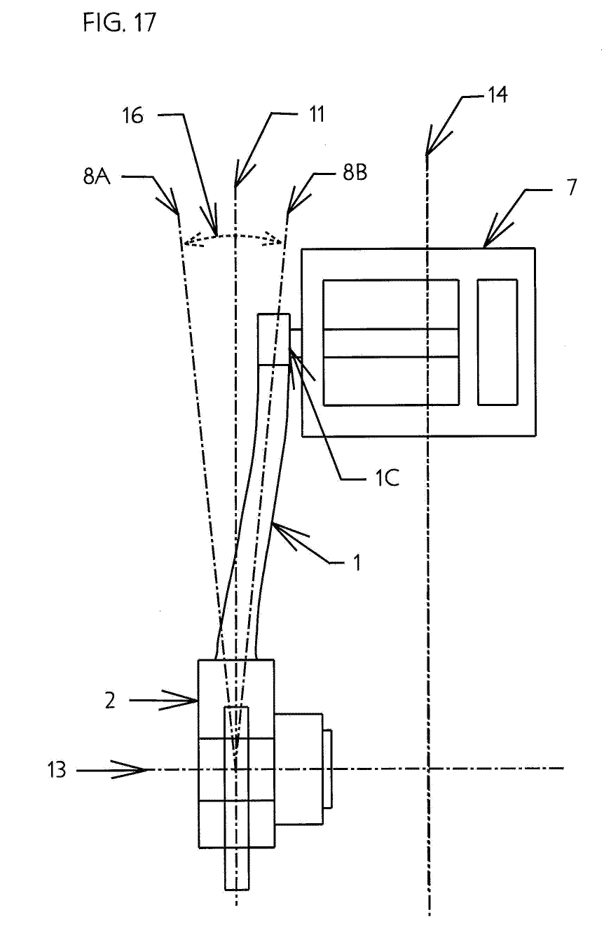

For increased heel and foot clearance during pedaling (FIG. 16 referenced by bottom bracket axis and vertical center plane of bicycle (14)), the included angle (15) of the structural neutral axis of the crank arm (8A) relative to the bottom bracket axis (13) is well over 90°. If the second axis of crank arm rotation (11) is 90° to the bottom bracket axis (13), the rotation of the structural neutral axis of the crank arm from riding configuration (8A) to 180° rotation (8B) around the second axis of crank arm rotation (11) is conical (16) (FIG. 17), and the rotation therefore reduces the distance from the crank pedal eye (1C) to the vertical center plane of the bicycle (14) to a percentage of the base diameter of the cone (16) generated around the second axis of crank arm rotation (11) by the structural neutral axis of the crank arm (8A, 8B).

It can be easily seen that the crank arm (1) and pedal (7) can quickly be returned to extended riding configuration by simply squeezing the lock lever (4), rotating the crank arm (1), and then releasing the lock lever (4). In addition, rotation of the crank arm (1) is made considerably easier by using the pedal (7) as an additional lever or handle by which to rotate the crank arm (1).

Any standard bicycle pedal will screw into the standard pedal eye at the outer end of the crank arm (1C) and remain securely attached to the crank arm (1) as the crank arm (1) and pedal (7) rotate together to complete the folding and unfolding process. Therefore, the rider is not limited to one of the few folding pedals available but can instead select from the vast array of aftermarket pedal designs.

This invention can be easily presented with a variety of minor modifications and still maintain the integrity of the invention of the addition of a lockable second axis of crank arm rotation (11) roughly parallel to the structural neutral axis of the crank arm to enable the crank arm (1), when released by a locking key or keys (4A), to rotate up to a full 360° around this second axis of crank arm rotation (11).

I claim:

1. A method to reduce bicycle shipping and storage width through the addition of a lockable second axis of crank arm rotation roughly parallel to the structural neutral axis of the crank arm.

2. According to claim 1, a reduction in shipping and storage width created as the pedal, in its fixed extended position relative to the crank arm, rotates with the crank arm as the crank arm rotates on its second axis of rotation 90° or more.

3. According to claim 1, a reduction in bicycle shipping and storage width, greater than pedal extension, due to the conical rotation of the structural neutral axis of the crank arm around the second axis of crank arm rotation.

4. According to claim 1, a crank arm adapter, one at each end of the bottom bracket, that encases one end of the crank arm thereby restricting all crank arm movement except for normal pedaling action and rotation around the lockable second axis of crank arm rotation.

5. According to claim 1, a crank arm retainer with a U shaped fork at one end that partially encircles a circular groove in the crank arm to prevent any movement of the crank arm along its second axis of rotation.

6. According to claim 1, a lock lever(s) that is mounted in the crank arm adapter, pivots on a lock lever pin(s), and is default loaded by a spring to lock any crank arm movement around the crank arm's second axis of rotation.

7. According to claim 1, a lock lever key(s), that inserts into a groove(s) in the crank arm to prevent any rotational movement of the crank arm on its second axis of rotation.

8. According to claim 1, any variation in the execution of this invention that effectively changes pedal position by rotating the crank arm around a second axis of crank arm rotation.
